(19) United States
(12) Patent Application Publication
(10) Pub. No.: US 2026/0149273 A1
(43) Pub. Date: May 28, 2026

(54) PHOTOVOLTAIC POWER GENERATING SYSTEM AND METHOD

(71) Applicants: Hyundai Motor Company, Seoul (KR); Kia Corporation, Seoul (KR); WEBSEN CO., LTD., Ansan (KR)

(72) Inventors: Jong Guk Bae, Hwaseong (KR); Hyung Woo Moon, Hwaseong (KR); Yeon Jong Ryu, Hwaseong (KR); Seong Chul Ahn, Hwaseong (KR); Hyun Seung Kim, Hwaseong (KR); Dal Ho Sim, Gwacheon (KR); Jong Hwan Kim, Seoul (KR); Kyoung Ah Lee, Namyangju (KR)

(21) Appl. No.: 19/278,651

(22) Filed: Jul. 23, 2025

(30) Foreign Application Priority Data
Nov. 25, 2024 (KR) 10-2024-0169651

(51) Int. Cl. H02J 3/00; H02J 3/38; H02J 13/00

(52) U.S. Cl. CPC H02J 3/0012; H02J 3/381; H02J 13/12; H02J 13/36; H02J 2101/24

(57) ABSTRACT

A photovoltaic power generating system includes a plurality of photovoltaic strings including a plurality of photovoltaic modules connected in series, an inverter that converts direct current supplied from the photovoltaic (solar cell) strings into alternating current and transmits the converted current to a power-consuming device, and a controller that determines whether a ground fault occurs in each of the photovoltaic strings on the basis of actual open-circuit voltages of the photovoltaic strings, and electrically disconnects a faulty photovoltaic string in which the ground fault occurs among the plurality of photovoltaic strings from the inverter.

### CROSS-REFERENCE TO RELATED APPLICATION

This application claims under 35 U.S.C. § 119(a) the benefit of Korean Patent Application No. 10-2024-0169651 filed on Nov. 25, 2024, the entire contents of which are incorporated herein by reference.

### BACKGROUND

### (a) Technical Field

The present disclosure relates to a photovoltaic power generating system and method, more particularly, to the photovoltaic power generating system and method for minimizing power generation loss due to a ground fault during power generation of photovoltaic strings.

### (b) Description of the Related Art

Generally, a photovoltaic power generating system includes a ground fault detector for detecting a DC ground fault in an inverter or a distribution panel.

A related-art photovoltaic power generating system stops power generation in a case where occurrence of a DC ground fault is detected by a ground fault detector. Accordingly, in a case where the DC ground fault occurs in the photovoltaic power generating system, power generation loss occurs due to stoppage of power generation.

Further, in the related-art photovoltaic power generating system, since it is difficult to recognize a location where the DC ground fault occurs, fire risk increases and inspection convenience decreases due to a prolonged inspection time.

In addition, since the related-art photovoltaic power generating system is not provided with a pre-check function for the DC ground fault, it is possible to confirm whether the DC ground fault occurs only after a power generating operation is started, and thus, power generation loss occurs in a case where the DC ground fault is detected during the power generation.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a photovoltaic power generating system and method capable of minimizing power generation loss due to occurrence of ground faults during power generation of photovoltaic strings.

In one aspect, the present disclosure provides a photovoltaic power generating system including a plurality of photovoltaic strings including a plurality of photovoltaic modules connected in series, an inverter that converts direct current supplied from the photovoltaic (solar cell) strings into alternating current and transmits the converted current to a power-consuming device, and a controller that determines whether a ground fault occurs in each of the photovoltaic strings on the basis of (i.e., by measuring) actual open-circuit voltages of the photovoltaic strings, and electrically disconnects a faulty photovoltaic string in which the ground fault occurs among the plurality of photovoltaic strings from the inverter.

In an embodiment, the photovoltaic strings and the inverter may be connected through a plurality of string output lines, and a relay for selectively blocking the connection between the photovoltaic strings and the inverter may be provided on each of the string output lines.

In another embodiment, a string voltage detecting section for measuring the actual open-circuit voltage of each of the photovoltaic strings may be provided in each of the string output lines in a state in which the relay is in an off state.

In still another embodiment, the controller may compare, in a case where an open-circuit voltage of a photovoltaic array measured in a combiner box output line that connects the relay and the inverter is equal to or greater than a predetermined pre-check operation starting voltage, the actual open-circuit voltage of each of the photovoltaic strings with a predetermined reference open-circuit voltage before the operation of the inverter is started, and may determine a photovoltaic string having the actual open-circuit voltage smaller than a predetermined percentage value of the reference open-circuit voltage as the faulty photovoltaic string.

In yet another embodiment, the controller may transmit location information of the faulty photovoltaic string to a monitoring device, and the monitoring device may generate an alarm for providing the location information of the faulty photovoltaic string.

In still yet another embodiment, the controller may stop, in a case where a ground fault detection signal is received from the inverter after the operation of the inverter is started, the operation of the inverter and then compare the actual open-circuit voltage of each photovoltaic string with a predetermined reference open-circuit voltage, and may determine a photovoltaic string having the actual open-circuit voltage smaller than a predetermined percentage value of the reference open-circuit voltage as the faulty photovoltaic string.

In a further embodiment, the controller may re-start power generation of the remaining photovoltaic strings except the faulty photovoltaic string among the plurality of photovoltaic strings in a state in which the relay on the string output line connected to the faulty photovoltaic string maintains an off state.

In another further embodiment, the controller may measure an open-circuit voltage of a photovoltaic array on a combiner box output line that connects the relay and the inverter, and may determine, in a case where the open-circuit voltage of the photovoltaic array is less than a predetermined percentage value of a predetermined reference open-circuit voltage, that the ground fault occurs on the combiner box output line.

In still another further embodiment, the open-circuit voltage of the photovoltaic array may be measured in a state in which all the relays provided on the string output lines are in an off state.

In yet another further embodiment, the photovoltaic array may be configured by connecting the plurality of photovoltaic strings in parallel.

In still yet another further embodiment, the controller may generate an alarm indicating the occurrence of the ground fault in the combiner box output line.

In a still further embodiment, the controller may determine, in a case where the open-circuit voltage of the photovoltaic array is equal to or greater than the predetermined percentage value of the reference open-circuit voltage, that the ground fault does not occur on the combiner box output line.

In a yet still further embodiment, the controller may measure the open-circuit voltage of the photovoltaic array in a state in which only the relay connected to one target photovoltaic string among the plurality of photovoltaic strings is turned on, and may determine, in a case where the open-circuit voltage of the photovoltaic array is equal to or greater than the predetermined percentage value of the reference open-circuit voltage, the target photovoltaic string as the faulty photovoltaic string.

In another embodiment, the controller may determine, in a case where the open-circuit voltage of the photovoltaic array is smaller than the predetermined percentage value of the reference open-circuit voltage, that the target photovoltaic string is not the faulty photovoltaic string.

In still another embodiment, the controller may transmit location information of the faulty photovoltaic string to a monitoring device, and may generate an alarm for notifying a location of the faulty photovoltaic string through the monitoring device.

According to another aspect of the present disclosure, a photovoltaic power generating method includes steps of: connecting a plurality of photovoltaic strings including a plurality of photovoltaic modules in series; converting, by an inverter, direct current supplied from the photovoltaic strings into alternating current and transmitting the converted current to a power-consuming device; and determining, by a controller, whether a ground fault occurs in each of the photovoltaic strings by measuring actual open-circuit voltages of the photovoltaic strings, and electrically disconnecting a faulty photovoltaic string in which the ground fault occurs among the plurality of photovoltaic strings from the inverter.

According to an embodiment, the controller transmits location information of the faulty photovoltaic string to a monitoring device, and the monitoring device generates an alarm for providing the location information of the faulty photovoltaic string.

Other aspects and embodiments of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinafter by way of illustration only, and thus are not limitative of the present disclosure, and wherein:

FIG. 1 is a diagram showing a photovoltaic power generating system according to an embodiment of the present disclosure;

FIG. 2 is a diagram showing a configuration of a controller provided in the photovoltaic power generating system according to the embodiment of the present disclosure;

FIG. 3 is a diagram showing a configuration of a fault detector provided in the photovoltaic power generating system according to the embodiment of the present disclosure;

FIG. 4 is a diagram showing a configuration of a photovoltaic combiner box provided in the photovoltaic power generating system according to the embodiment of the present disclosure;

FIG. 5 is a flowchart showing a reference open-circuit voltage determination process in the photovoltaic power generating system according to the embodiment of the present disclosure;

FIG. 6 is a flowchart showing a ground fault determination process for each photovoltaic string before starting power generation in the photovoltaic power generating system according to the embodiment of the present disclosure;

FIG. 7 is a flowchart showing a ground fault determination process for each photovoltaic string after starting power generation in the photovoltaic power generating system according to the embodiment of the present disclosure; and

FIG. 8 is a flowchart showing a ground fault determination process of a photovoltaic combiner box and a ground fault re-determination process for each photovoltaic string in the photovoltaic power generating system according to the embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

It will be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the exemplary embodiments of the present disclosure.

A photovoltaic power generating system according to an embodiment of the present disclosure is configured to minimize power generation loss due to ground fault during power generation of a photovoltaic string. Further, the photovoltaic power generating system is configured to prevent safety incidents due to the ground fault by detecting occurrence of the ground fault through a pre-check.

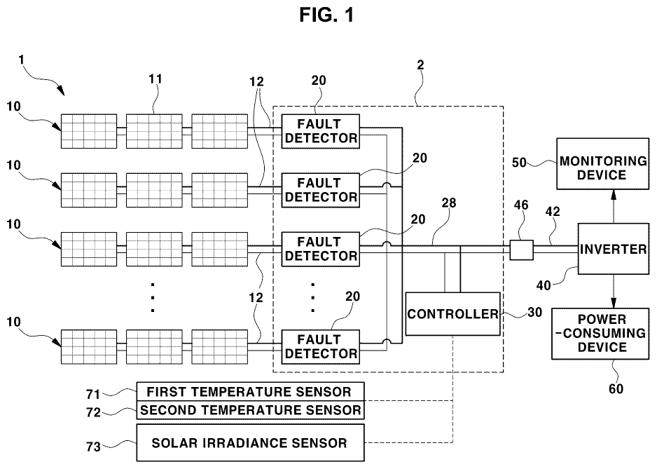

As shown in FIG. 1, a photovoltaic power generating system according to an embodiment of the present disclosure includes a plurality of photovoltaic strings 10, an inverter 40 for power conversion of the photovoltaic strings 10, a photovoltaic combiner box 2 provided between the photovoltaic strings 10 and the inverter 40, and a monitoring device 50 that constantly collects ground fault information for the photovoltaic strings 10.

Each of the photovoltaic strings 10 includes a plurality of photovoltaic modules 11 that are connected in series. Each of the photovoltaic modules 11 includes solar cells that are connected in series and/or parallel. In addition, the plurality of photovoltaic strings 10 is connected in parallel, and a set of the photovoltaic strings 10 connected in this way is referred to as a photovoltaic array 1.

In order to protect various devices that electrically connect the photovoltaic strings 10 and the inverter 40, the photovoltaic combiner box 2 collectively accommodates the devices. Specifically, the photovoltaic combiner box 2 accommodates a plurality of fault detectors 20, a controller 30, and the like.

The plurality of fault detectors 20 are connected to the photovoltaic strings 10 through a plurality of string output lines 12. Each of the fault detectors 20 is individually connected to each photovoltaic string 10 through each string output line 12. Each fault detector 20 is provided for each power line (that is, the string output line) of the photovoltaic string 10.

The fault detectors 20 are connected to the inverter 40 in series through a power line (that is, combiner box output line) of the photovoltaic combiner box 2 and a power line (that is, inverter input line) of the inverter 40. The inverter input line 42 is connected to the string output lines 12 in series. The fault detectors 20 are connected to each other in parallel. The combiner box output line 28 and the inverter input line 42 are connected to each other in series, and are distinguished from each other with reference to a circuit breaker 46. Here, the combiner box output line 28 may be referred to as an output line of the photovoltaic array 1. A circuit breaker that is generally used in an electrical circuit may be used as the circuit breaker 46.

The controller 30 is connected to the combiner box output line 28 in parallel. The controller 30 is connected to the fault detectors 20 through the combiner box output line 28. The controller 30 receives information about states of the respective photovoltaic strings 10 from the fault detectors 20 and transmits the result to a monitoring device 50. The information about the states of the photovoltaic strings 10 includes output voltages, output currents of the photovoltaic strings 10 and opening/closing states of the string output lines 12.

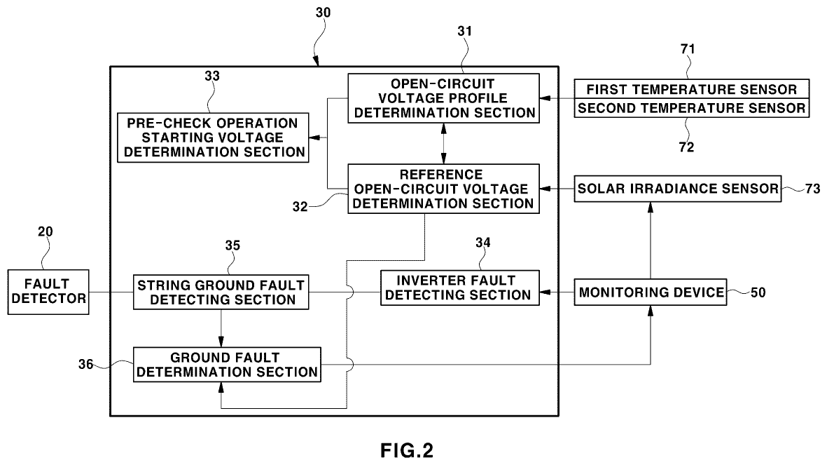

Referring to FIG. 2, the controller 30 may include an open-circuit voltage profile determination section 31, a reference open circuit determination section 32, a pre-check operation starting voltage determination section 33, an inverter fault detecting section 34, a string ground fault detecting section 35, a ground fault determination section 36.

The open-circuit voltage profile determination section 31 is configured to calculate and determine an open circuit profile according to changes in solar radiation on the basis of an outside temperature and temperature of the photovoltaic module 11. The outside temperature is a temperature at a location where the photovoltaic array 1 is provided. The photovoltaic array 1 may be provided with a first temperature sensor 71 for measuring the outside temperature and a second temperature sensor 72 for measuring the temperature of the photovoltaic module 11.

The reference open-circuit voltage determination section 32 is configured to calculate and determine a reference open-circuit voltage on the basis of the outside temperature, and the temperature and solar irradiance of the photovoltaic module 11. The solar irradiance refers to solar irradiance at a location where the photovoltaic array 1 is provided, and may be measured through a solar irradiance sensor 73 provided at the location or in the photovoltaic array 1.

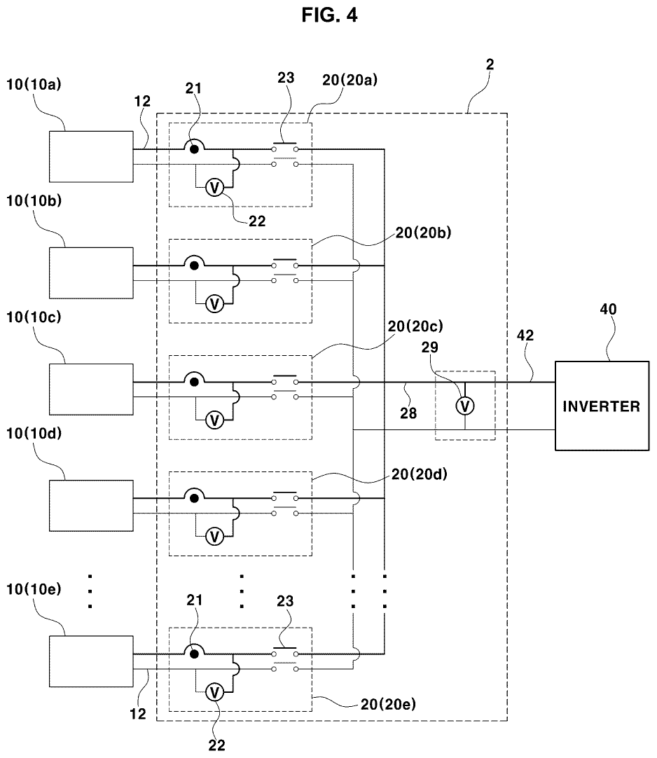

The pre-check operation starting voltage determination section 33 is configured to select and determine the pre-check operation starting voltage on the basis of the open-circuit voltage profile determined by the open circuit profile determination section 31. In a case where the pre-check operation starting voltage determination section 33 detects information indicating that an open-circuit voltage (V_{LO}) of the photovoltaic combiner box 2 before the operation of the inverter 40 is started reaches the pre-check operation starting voltage, the pre-check operation starting voltage determination section 33 transmits the detected information to the string ground fault detecting section 35. As shown in FIG. 4, a combiner box voltage detecting section 29 for measuring the open-circuit voltage (V_{LO}) of the photovoltaic combiner box 2 is provided in the combiner box output line 28. Here, the open-circuit voltage (V_{LO}) of the photovoltaic combiner box 2 refers to the open-circuit voltage of the photovoltaic array 1.

The inverter 40 converts direct current that is output and supplied by the photovoltaic string 10 in power generation of the photovoltaic string 10 into alternating current, and transmits the result to a power-consuming device 60. Further, although not specifically shown, the inverter 40 includes a ground fault detector (not shown) for detecting whether a ground fault occurs in an internal circuit thereof.

Generally, an inverter used in a photovoltaic power generating system includes a ground fault detector (which may be referred to as a fault detector) for detecting occurrence of a ground fault in a power line in a photovoltaic power generating system. Since the technology in which the inverter of the photovoltaic power generating system includes the ground fault detector to detect the occurrence of the ground fault of the power line is already known, detailed description thereof will be omitted.

In a case where the inverter fault detecting section 34 detects a ground default of the power line in the photovoltaic power generating system through the ground fault detector of the inverter 40, the inverter fault detecting section 34 receives information on the detected ground fault through the monitoring device 50.

The monitoring device 50 constantly communicates with the inverter 40. In a case where the ground fault detector provided in the inverter 40 detects the ground fault in the power line of the photovoltaic power generating system, the monitoring device 50 receives the ground fault information detected by the ground fault detector from the inverter 40. The monitoring device 50 transmits the ground fault information received from the inverter 40 to the inverter fault detecting section 34 of the controller 30.

The string ground fault detecting section 35 is configured to detect the ground fault for the photovoltaic strings 10. In a case where the string ground fault detecting section 35 receives the ground fault information about the power line in the photovoltaic power generating system from the inverter fault detecting section 34 and receives information indicating that the open-circuit voltage (V_{LO}) of the photovoltaic array 1 reaches the pre-check operation starting voltage from the pre-check operation starting voltage determination section 33, the string ground fault detecting section 35 detects the ground fault for the photovoltaic strings 10 after the information reception.

The ground fault determination section 36 is configured to predict the occurrence of the ground fault for each photovoltaic string 10. To this end, the ground fault determination section 36 compares the reference open-circuit voltage received from the reference open-circuit voltage determination section 32 with each open-circuit voltage for each photovoltaic string 10 received from the fault detector 20, and predicts and determines whether a ground fault occurs in each of the photovoltaic strings 10 on the basis of the comparison result. The ground fault determination section 36 transmits information about the photovoltaic string 10 in which the ground fault occurs to the fault detector 20 and the monitoring device 50.

The ground fault determination section 36 transmits and provides location information of the photovoltaic string (that is, faulty photovoltaic string) for which the ground fault is predicted and determined to the monitoring device 50. The monitoring device 50 may provide the location information of the faulty photovoltaic string in which the ground fault occurs on the basis of the ground fault information received from the ground fault determination section 36 to a manager. The monitoring device 50 may include and/or control a device for visually and/or audibly providing the ground fault information of the photovoltaic string 10 to the manager.

For example, the monitoring device 50 may light a light emitting diode (LED) provided in the photovoltaic string 10, thereby providing the location information of the photovoltaic string in which the ground fault occurs to the manager. Further, the monitoring device 50 may include a display for displaying the location information of the photovoltaic string in which the ground fault occurs. In addition, the monitoring device 50 may include a display for displaying power generation of the photovoltaic power generating system and an operating status thereof in real time. The manager may monitor the power generation of the photovoltaic power generating system and the operating status thereof in real time.

Here, the faulty photovoltaic string refers to a photovoltaic string in which the ground fault occurs among the plurality of photovoltaic strings 10 provided in the photovoltaic power generating system. The faulty photovoltaic string may include one or more photovoltaic strings in which the ground fault occurs.

In addition, the ground fault determination section 36 transmits a relay off signal to the fault detector (first fault detector) connected to the faulty photovoltaic string. A relay provided in the first fault detector maintains an off state by the relay off signal. Here, the first fault detector refers to a fault detector provided in the photovoltaic string (that is, faulty photovoltaic string) in which the ground fault occurs.

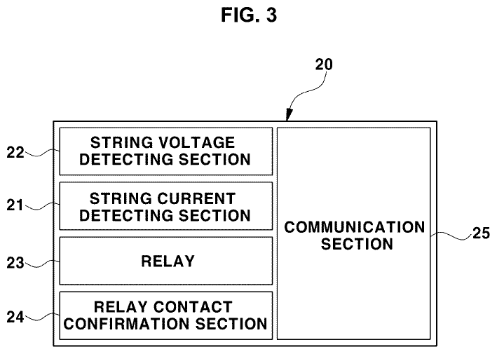

Referring to FIGS. 3 and 4, the fault detector 20 includes a string current detecting section 21, a string voltage detecting section 22, a pair of relays 23, a communication section 25, and a relay contact confirmation section 24.

The string current detecting section 21 is provided for each string output line 12, measures output current of the photovoltaic string 10 on the string output line 12, and transmits the result to the controller 30.

The string voltage detecting section 22 is provided for each string output line 12, measures output voltage (that is, actual open-circuit voltage) of the photovoltaic string 10 on the string output line 12, and transmits the result to the controller 30. The string voltage detecting section 22 measures the actual open-circuit voltage (Vstring) in a state in which the string output line 12 is opened. As the pair of relays 23 is turned on, the string output line 12 is opened.

The pair of relays 23 is turned off by the relay off signal transmitted by the controller 30, or maintains the off state. Further, the pair of relays 23 is turned on by a relay on signal transmitted by the controller 30, or maintains the on state.

The communication section 25 performs communication between the fault detector 20 and the controller 30. Specifically, the communication section 25 transmits state information of the photovoltaic string 10 detected by the fault detector 20 to the controller 30, and receives a relay control signal such as a relay off signal or a relay on signal transmitted by the controller 30.

In addition, the relay contact confirmation section 24 is configured to detect and confirm whether the pair of relays 23 is turned on or off in the fault detector 20. The relay contact confirmation section 24 detects whether a moving contact provided in each relay 23 is in contact with its fixed contact so that a corresponding circuit is conductively closed.

In the present embodiment, the controller 30 determines whether the ground fault occurs in each photovoltaic string 10 on the basis of the actual open-circuit voltage of the photovoltaic string 10. As a result of the determination, the photovoltaic string in which the ground fault occurs (that is, faulty photovoltaic string) is electrically disconnected from the inverter 40. To this end, the relay of the first fault detector connected to the faulty photovoltaic string is controlled to become off.

The controller 30 may determine whether the ground fault occurs before and after the operation of the inverter 40 is started. The controller 30 may predict and determine whether the ground fault occurs for each photovoltaic string 10 through the pre-check before the operation of the inverter 40 is started for photovoltaic power generation.

In order to detect the ground fault for each photovoltaic string 10 before the operation of the inverter 40 is started, the controller 30 determines whether the open-circuit voltage (V_{LO}) of the photovoltaic array 1 reaches the pre-check operation starting voltage. In a case where the open-circuit voltage (V_{LO}) of the photovoltaic array 1 reaches the pre-check operation starting voltage, the controller 30 executes the pre-check. Before the operation of the inverter 40 is started, the open-circuit voltage (V_{LO}) of the photovoltaic array 1 does not reach the operation starting voltage (that is, starting voltage) of the inverter 40.

In a case where the output current of the photovoltaic string 10 is 0 A, the controller 30 starts and executes the pre-check. By detecting the occurrence of the ground fault for each photovoltaic string 10 before the operation of the inverter 40 is started, it is possible to protect various devices (for example, relays or the like) provided in the photovoltaic power generating system and improve operational safety.

The controller 30 sequentially and individually performs the ground fault prediction and detection of the photovoltaic strings 10 that form the photovoltaic array 1. To this end, the relay 23 in the fault detector 20 connected to each photovoltaic string 10 is turned off, or maintains the off state.

Referring to FIG. 4, the ground fault prediction and detection is performed in the order of a first photovoltaic string 10a, a second photovoltaic string 10b, a third photovoltaic string 10c, a fourth photovoltaic string 10d, . . . , and a n-th photovoltaic string 10e.

The controller 30 sequentially measures and acquires the actual open-circuit voltage values of the respective photovoltaic strings 10. Here, the actual open-circuit voltages of the photovoltaic strings 10 are measured through the string voltage detecting section 22 in the fault detector 20.

The controller 30 compares the actual open-circuit voltage of the photovoltaic string 10 with a predetermined percentage value (Vref×a %) of a reference open-circuit voltage (Vref). In a case where the open-circuit voltage of the photovoltaic string 10 is smaller than the predetermined percentage value of the reference open-circuit voltage (Vref), the controller 30 disconnects the output line of the corresponding photovoltaic string from the inverter 40. In other words, the controller 30 electrically disconnects the photovoltaic string (that is, faulty photovoltaic string) having the open-circuit voltage smaller than the predetermined percentage value of the reference open-circuit voltage (Vref) from the inverter 40.

Here, the controller 30 maintains the relay 23 in the first fault detector connected to the faulty photovoltaic string in the off state to disconnect the faulty photovoltaic string from the inverter 40.

The reference open-circuit voltage (Vref) is determined on the basis of temperature and solar irradiance, in which are main change factors in photovoltaic power generation. In other words, the reference open-circuit voltage (Vref) is determined on the basis of outside temperature, temperature and solar irradiance of the photovoltaic module 11. In addition, the predetermined percentage value of the reference open-circuit voltage (Vref) is determined as a value (Vref×a %) obtained by multiplying the reference open-circuit voltage (Vref) by the predetermined ratio (a %). Specifically, the reference open-circuit voltage (Vref) may be calculated according to the following expression.

$$V ref = N series\_modules \times N series\_cells \times ( n \times k \times T ) / q \times ln ( A \times Iscs \times G / {G}_{D} + 1 ) \qquad [ Expression 1 ]$$

In Expression 1, “N series_modules” represents the number of photovoltaic modules 11 included in each photovoltaic string 10 and connected in series, and “N series_cells” represents the number of solar cells (or solar battery cells) included in each photovoltaic module 11. Further, “Iscs” represents a short circuit current of a solar cell according to STC (Standard Test Conditions), “G_{D}” represents solar irradiance (1000 W/m²) according to the STC, “G” represents an actual solar irradiance, “n” represents an abnormal factor, “k” represents the Boltzmann constant, “T” represents an outside temperature or temperature of the photovoltaic module 11, “q” represents a unit charge, and “A” represents a correction coefficient.

Specifically, the STC condition include a light receiving condition, a light intensity, and a reference temperature. The light receiving condition is based on an area of an air mass (AM) constant of 1.5, and the light intensity is based on 1,000 (W/m²). In addition, the reference temperature is a reference temperature of all tests, which is determined as 25° C.

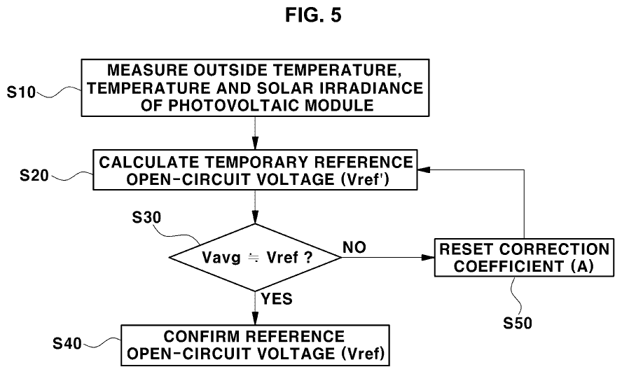

Further, the correction coefficient A is a correction coefficient in which saturation current characteristics of the photovoltaic module 11 and shape characteristics of the photovoltaic module 11 are reflected when sunlight is not incident. The reference open-circuit voltage (Vref) is determined by adjusting the correction coefficient A (see FIG. 5). The correction coefficient A may be reset at a user desired time point, and reflects output change characteristics according to interannual variation in the photovoltaic power generating system. The correction coefficient A is determined as such a value that the reference open-circuit voltage (Vref) and an average open-circuit voltage (Vavg) of the photovoltaic power generating system become identical within a margin range.

Referring to FIG. 5, the outside temperature, the temperature and solar irradiance of the photovoltaic module 11 are measured (S10). The measured outside temperature and the temperature and solar irradiance of the photovoltaic module 11 are input to Expression 1 to calculate a temporary reference open-circuit voltage (Vref′) (S20). The calculated temporary reference open-circuit voltage (Vref′) is compared with the average open-circuit voltage (Vavg) of the photovoltaic power generating system (S30). In a case where the temporary reference open-circuit voltage (Vref′) and the average open-circuit voltage (Vavg) are identical within the margin range, the temporary reference open-circuit voltage (Vref′) is determined as the reference open circuit value (Vref) that is a voltage value compared with the open-circuit voltage of the photovoltaic string 10 in detecting the ground fault of the photovoltaic string (S40). In a case where a difference between the reference open-circuit voltage (Vref) and the average open-circuit voltage (Vavg) exceeds the predetermined margin range, the correction coefficient A is adjusted and reset (S50). In other words, the reference open-circuit voltage (Vref) may be corrected as a value obtained by subtracting the predetermined margin from the average open-circuit voltage (Vavg) or adding the predetermined margin to the average open-Circuit voltage (Vavg).

The reference open-circuit voltage (Vref) may be corrected and adjusted using the correction coefficient A in a case where the open-circuit voltages (that is, entire open-circuit voltage) of all the photovoltaic strings 10 are uniform after the photovoltaic power generating system is initially installed.

In a case where the faulty photovoltaic string in which the ground fault occurs is detected during measurement of the open-circuit voltage for each photovoltaic string 10, the controller 30 transmits information about the faulty photovoltaic string to the monitoring device 50. The controller 30 checks the ground fault of all the photovoltaic strings 10 regardless of the presence or absence of detection of the ground fault.

In a case where the pre-check for predicting and checking whether the ground fault occurs for all the photovoltaic strings 10 is finished, the controller 30 operates the remaining photovoltaic strings (that is, photovoltaic strings in which the ground fault does not occur) except the photovoltaic strings with the ground fault, and restarts the operation of the inverter 40.

The controller 30 transmits the information about the faulty photovoltaic string to the monitoring device 50, and the monitoring device 50 operates an alarm for displaying a location of the faulty photovoltaic string to notify the manager of the result.

Further, in a case where the information about the ground fault occurrence of the photovoltaic power generating system is received after the power generation of the photovoltaic string 10 and the operation of the inverter 40 are started (that is, during the operation of the inverter 40), the controller 30 detects the ground fault for each photovoltaic string 10. The controller 30 may receive the ground fault occurrence information from the monitoring device 50. The monitoring device 50 constantly communicates with the inverter 40, and may receive the ground fault occurrence information from the inverter 40.

The ground fault detector provided in the inverter 40 can detect only the photovoltaic string where the ground fault occurs in the photovoltaic power generating system, and cannot detect a specific location in the photovoltaic power generating system where the ground fault occurs. In other words, the ground fault detector in the inverter 40 cannot detect a certain photovoltaic string where the ground fault occurs among the photovoltaic strings 10 included in the photovoltaic power generating system.

Accordingly, in a case where the controller 30 recognizes the ground fault of the photovoltaic power generating system during the power generation of the photovoltaic strings 10 and the operation of the inverter 40, the controller 30 stops the operation of the inverter 40 and detects the ground fault for each photovoltaic string 10. That is, in a case where the ground fault of the photovoltaic power generating system is detected by the inverter 40, the controller 30 stops the operation of the inverter 40 and detects the ground fault for each photovoltaic string 10.

The process of detecting the ground fault for each photovoltaic string 10 may be performed in a similar way to the process of checking the occurrence of the ground fault of the photovoltaic string 10 during pre-check. That is, the controller 30 sequentially turns off the relays 23 of the fault detectors 20 connected to the respective photovoltaic strings 10, and measures and acquires the open-circuit voltage values of the respective photovoltaic strings 10. In a case where the photovoltaic string with the ground fault is detected, the controller 30 electrically disconnects the faulty photovoltaic string from the inverter 40.

After the faulty photovoltaic string is electrically disconnected from the inverter 40, the operation of the inverter 40 is restarted to perform photovoltaic power generation, thereby minimizing power generation loss due to the ground fault.

In addition, the controller 30 may detect the ground fault of the combiner box output line 28 regardless of the detection of the ground fault of the photovoltaic string 10. To this end, the controller 30 receives the open-circuit voltage (V_{LO}) of the photovoltaic array 1 from the combiner box voltage detecting section 29 provided in the combiner box output line 29.

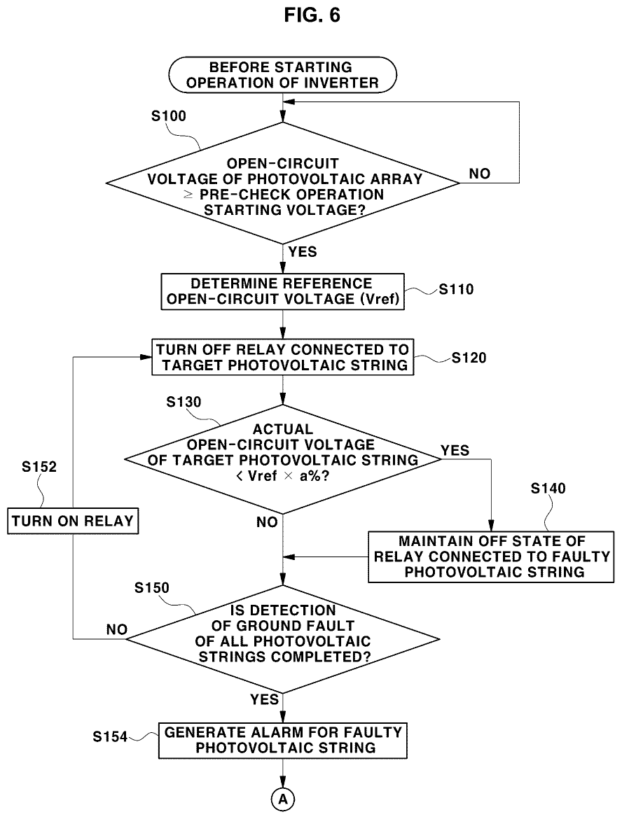

Here, the method of detecting the ground fault of the photovoltaic string 10 will be described in more detail with reference to FIGS. 6 to 8.

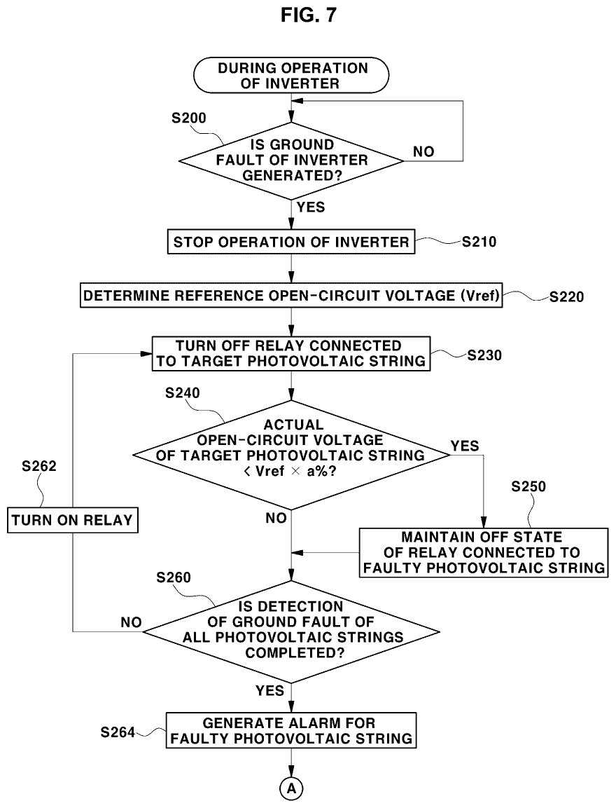

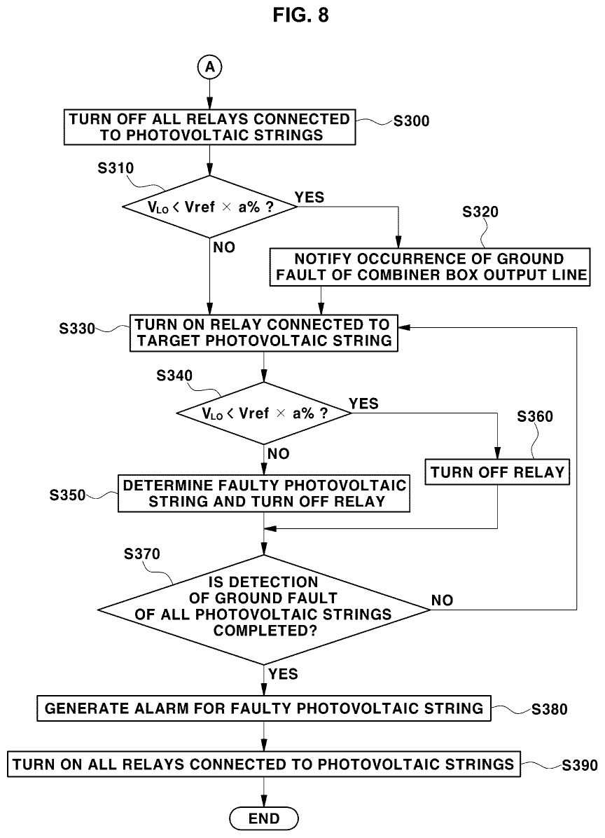

FIG. 6 is a flowchart showing a ground fault determination process for each photovoltaic string before starting power generation in the photovoltaic power generating system according to the embodiment of the present disclosure, and FIG. 7 is a flowchart showing a ground fault determination process for each photovoltaic string after starting power generation in the photovoltaic power generating system according to the embodiment of the present disclosure. FIG. 8 is a flowchart showing a ground fault determination process of a photovoltaic combiner box and a ground fault re-determination process for each photovoltaic string in the photovoltaic power generating system according to the embodiment of the present disclosure.

In the present disclosure, the photovoltaic strings 10 individually predict and detect the ground fault. Here, the photovoltaic string 10 that currently predicts and detects the ground fault may be referred to as a “target photovoltaic string”, and the fault detector 20 connected to the target photovoltaic string 10 may be referred to as a “target fault detector”. The controller 30 measures and acquires an open-circuit voltage value of the target photovoltaic string 10 through the string voltage detecting section 22 when the relay 23 in the target fault detector 20 is turned off.

Here, since the target photovoltaic string 10 is one of the photovoltaic strings 10 in the photovoltaic power generating system, the target photovoltaic string 10 is given the same reference numeral as the photovoltaic string 10. Similarly, since the target fault detector 20 is one of the fault detectors 20 in the photovoltaic power generating system, the target fault detector 20 is given the same reference numeral as the fault detector 20.

The pre-check for the photovoltaic string 10 may be performed through the photovoltaic string ground fault determination process shown in FIG. 6, and the ground fault detection for each photovoltaic string 10 may be performed during the operation of the inverter 40 for power generation of the photovoltaic string 10 through the photovoltaic string ground fault determination process shown in FIG. 7.

The photovoltaic string ground fault determination process shown in FIG. 6 may be performed in a case where the open-circuit voltage (V_{LO}) of the photovoltaic array 1 before the inverter 40 is operated reaches the pre-check operation starting voltage. Further, the photovoltaic string ground fault determination process shown in FIG. 7 may be performed in a case where the ground fault occurs in the inverter 40 while the inverter 40 is operated, and may be performed after the inverter 40 is turned off.

Referring to FIG. 6, in S100, the controller 30 compares the open-circuit voltage (V_{LO}) of the photovoltaic array 1 with the pre-check operation starting voltage before the operation of the inverter 40 is started.

The pre-check operation starting voltage is determined on the basis of an open-circuit voltage profile determined by the open-circuit voltage profile determination section 31. For example, the open-circuit voltage profile determination section 31 may form and determine the open-circuit voltage profile on the basis of a solar irradiance variation on the basis of the reference open-circuit voltage values calculated by reflecting actually measured outside temperatures or the temperatures of the photovoltaic modules 11 before sunrise every day in the above-mentioned Expression 1. Since the open-circuit voltage variation of the photovoltaic power generating system is large when the outside temperatures or the temperatures of the photovoltaic modules 11 are relatively low, the pre-check operation starting voltage value is selected and determined in a voltage section corresponding to 40% to 60% of a starting voltage of the inverter on the basis of the open-circuit voltage profile. The pre-check operation starting voltage may be determined on the basis of the open-circuit voltage profile and the inverter starting voltage. The pre-check operation starting voltage is determined as a value smaller than the starting voltage of the inverter 40.

In a case where the open-circuit voltage (V_{LO}) of the photovoltaic array 1 reaches the predetermined pre-check operation starting voltage and becomes equal to or greater than the pre-check operation starting voltage, the controller 30 calculates and determines the reference open-circuit voltage (Vref) in S110.

In a case where the reference open-circuit voltage (Vref) value is determined, the controller 30 turns off the relay 23 connected to the target photovoltaic string 10 in S120, and compares an actually measured open-circuit voltage (Vstring) of the target photovoltaic string 10 with the predetermined percentage value (Vref×a %) of the reference open-circuit voltage (Vref). The actual open-circuit voltage (Vstring) is an open-circuit voltage of the target photovoltaic string 10 measured in the off state of the relay 23.

The controller 30 determines, in a case where the actual open-circuit voltage (Vstring) of the target photovoltaic string 10 is less than the predetermined percentage value (Vref×a %) of the reference open-circuit voltage (Vref), that the ground fault occurs in the target photovoltaic string 10. “a” is set to a value than can be used to determine the occurrence of the ground fault of the target photovoltaic string through prior testing and evaluation.

In S140, the controller 30 maintains the off state of the relay 23 connected to the target photovoltaic string (that is, the faulty photovoltaic string) in which the ground fault occurs.

Further, as a result of the comparison in S130, in a case where the open-circuit voltage of the target photovoltaic string 10 is equal to or greater than the predetermined percentage value (Vref×a %) of the reference open-circuit voltage (Vref), the controller 30 determines that the ground fault does not occur in the target photovoltaic string 10, and then re-executes S120. After the controller 30 turns off the relay 23 connected to the next target photovoltaic string 10 in the re-execution step of S120, and the controller 30 compares an actual open-circuit voltage (Vstring) of the target photovoltaic string 10 with the predetermined percentage value (Vref×a %) of the reference open-circuit voltage (Vref) in the re-execution step of S130.

Here, the controller 30 executes S152 before the re-execution step of S120. In S152, the controller 30 turns on the relays 23 connected in series to the target photovoltaic string 10.

In addition, in a case where it is determined that the detection of the ground fault of the all the photovoltaic strings 10 is completed in S150, the controller 30 executes S154. In S154, the controller 30 generates an alarm indicating that a ground fault has occurred in the faulty photovoltaic string through the monitoring device 50. Through the alarm, it is possible for the manager to perform pre-maintenance of the photovoltaic power generating system, thereby preventing the occurrence of the ground fault.

Further, the controller 30 may perform S300 shown in FIG. 8 after S154.

The ground fault pre-check before the operation of the inverter 40 is started may be periodically executed, and the execution cycle may be set by a user or administrator.

In addition, the ground fault of the inverter 40 may be detected through the ground fault detector provided in the inverter 40 during the operation of the inverter 40. The ground fault detector in the inverter 40 may constantly detect the ground fault of the inverter 40 in a case where a predetermined condition is satisfied.

Referring to FIG. 7, in a case where the controller 30 receives and acquires the information on the occurrence of the ground fault of the inverter 40 in S200, the controller 30 temporarily stops the operation of the inverter 40 to detect the ground fault for each photovoltaic string 10 (S210).

Then, the controller 30 calculates and determines the reference open-circuit voltage (Vref) in S220. In a case where the reference open-circuit voltage (Vref) is determined, the controller 30 turns off the relay 23 connected to the target photovoltaic string 10 in S230, and compares the actual open-circuit voltage (Vstring) of the target photovoltaic string 10 with the predetermined percentage value (Vref×a %) of the reference open-circuit voltage (Vref) in S240.

In a case where the actual open-circuit voltage (Vstring) of the target photovoltaic string 10 is smaller than the predetermined percentage value (Vref×a %) of the reference open-circuit voltage (Vref), the controller 30 determines that the ground fault occurs in the target photovoltaic string 10, and maintains the off state of the relay 23 connected to the target photovoltaic string with the ground fault (that is, faulty photovoltaic string) in S250.

Further, as a result of the comparison in S240, in a case where the actual open-circuit voltage (Vstring) of the target photovoltaic string 10 is equal to or greater than the predetermined percentage value (Vref×a %) of the reference open-circuit voltage (Vref), the controller 30 determines that the ground fault does not occur in the target photovoltaic string 10, and then re-executes S230. The controller 230 turns off the relay 23 connected to the next target photovoltaic string 10 in the re-execution step of S230, and compares an open-circuit voltage of the next target photovoltaic string 10 with the predetermined percentage value (Vref×a %) of the reference open-circuit voltage (Vref) in the re-execution step of S240.

Here, the controller 30 executes S262 before the re-execution step of S230. In S262, the controller 30 turns on the relay 23 connected in series to the target photovoltaic string 10.

In addition, in a case where it is determined in S260 that the execution of the ground fault of all the photovoltaic strings 10 is completed, the controller 30 performs S264. In S264, the controller 30 generates an alarm for indicating that a ground fault has occurred in the faulty photovoltaic string.

Further, the controller 30 may perform S300 shown in FIG. 8 after S264.

Referring to FIG. 8, the controller 30 turns off the relays 23 connected to the photovoltaic strings 10 of the photovoltaic array 1 in S300.

In a subsequent step S310, the controller 30 measures the open-circuit voltage (V_{LO}) of the photovoltaic array 1 in the combiner box output line 28, and compares the measured open-circuit voltage (V_{LO}) with the predetermined percentage value (Vref×a %) of the reference open-circuit voltage (Vref). As a result of the comparison, in a case where the open-circuit voltage (V_{LO}) of the photovoltaic array 1 is less than the predetermined percentage value (Vref×a %) of the reference open-circuit voltage (Vref), the controller 30 determines that the ground fault occurs in the combiner box output line 28, and generates an alarm indicating the occurrence of the ground fault in the combiner box output line 28 (S320).

Here, the alarm indicating the occurrence of the ground fault in the combiner box output line 28 is generated through the monitoring device 50. The controller 30 transmits information on the combiner box output line 28 in which the ground fault occurs to the monitoring device 50. The manager may monitor and repair the ground fault of the photovoltaic power generating system in real time through the alarm.

The ground fault determination in the combiner box output line 28 may be performed regardless of whether the ground fault occurs in the photovoltaic string 10. The ground fault determination may be performed in terms of pre-check.

Further, as a result of the comparison in S310, in a case where the open-circuit voltage (V_{LO}) of the photovoltaic array 1 is equal to or greater than the predetermined percentage value (Vref×a %) of the reference open-circuit voltage (Vref), the controller 30 immediately executes S330. The controller 30 may execute S330 regardless of whether the ground fault occurs in the combiner box output line 28.

In S330, the controller 30 turns on only the relay 23 connected to a certain photovoltaic string (that is, target photovoltaic string) among all the photovoltaic strings 10 included in the photovoltaic array 1. Here, the controller 30 does not turn on the relays 23 connected to the remaining photovoltaic strings 10 except the target photovoltaic string 10 among the photovoltaic strings 10. In other words, the target photovoltaic string 10 corresponds to a photovoltaic string in which the string output line 12 is not opened as the relay 23 is turned on, among the plurality of photovoltaic strings 10. The relays 23 connected to the remaining photovoltaic strings 23 are in the off state.

In the next step S340, the controller 30 measures the open-circuit voltage (V_{LO}) of the photovoltaic array 1 in the combiner box output line 28, and compares the measured open-circuit voltage (V_{LO}) with the predetermined percentage value (Vref×a %) of the reference open-circuit voltage (Vref). As a result of the comparison, in a case where the open-circuit voltage (V_{LO}) of the photovoltaic array 1 is equal to or greater than the predetermined percentage value (Vref×a %) of the reference open-circuit voltage (Vref), the controller 30 executes S350, and in a case where the open-circuit voltage (V_{LO}) of the photovoltaic array 1 is less than the predetermined percentage value (Vref×a %) of the reference open-circuit voltage (Vref), the controller 30 executes S360.

In S350, the controller 30 determines that the ground fault occurs in the target photovoltaic string 10, and determines the target photovoltaic string 10 with the ground fault as a faulty photovoltaic string. Here, the controller 30 transmits information on the faulty photovoltaic string (for example, location information or the like) to the monitoring device 50. In addition, the controller 30 turns off the relay 23 connected to the faulty photovoltaic string in S350.

In S360, the controller 30 determines that the ground fault does not occur in the target photovoltaic string 10, and turns off the relay 23 connected to the target photovoltaic string 10.

In S370, the controller 30 determines whether the detection of the ground fault of all the photovoltaic strings 10 that form the photovoltaic array 1 is completed. As a result of the determination, in a case where the detection of the ground fault of all the photovoltaic strings 10 is executed, the controller 30 executes S380, and in a case where the detection of the ground fault of any one photovoltaic string 10 is not completed, the controller 30 re-executes S330.

As a result of repeated execution of S330 to S370, in a case where a determination is made that the ground fault detection of all the photovoltaic strings 10 is completed, the controller 30 notifies the monitoring device 50 that ground fault detection of all the photovoltaic strings 10 is completed, or requires the monitoring device 50 to generate the alarm for the faulty photovoltaic string.

In S380, the monitoring device 50 generates the alarm for the faulty photovoltaic string according to the notification or request of the controller 30.

In S390, the controller 30 turns on the relays 23 connected to the photovoltaic strings 10, starts the power generation of the photovoltaic strings 10, and stands by the operation of the inverter 40. In S390, the controller 30 turns on the remaining relays 23 except the relay connected to the faulty photovoltaic string among the relays 23 connected to the photovoltaic strings 10, and starts the power generation of the photovoltaic strings 10. That is, the controller 30 starts the power generation of the remaining photovoltaic strings 10 except the faulty photovoltaic string.

In a case where the detection of the ground fault of the photovoltaic strings 10 is finished, the controller 30 restarts the power generation of the photovoltaic strings 10, and thus, it is possible to minimize power generation loss caused by the occurrence of the ground fault during photovoltaic power generation.

According to the present disclosure, it is possible to double check the occurrence of the ground fault for the photovoltaic strings 10 by performing the steps shown in FIG. 8 after performing the steps shown in FIG. 6. Further, although not specifically described, the ground fault detection process of the photovoltaic strings 10 performed by the steps shown in FIG. 8 may be performed independently of the ground fault detection process of the photovoltaic strings 10 performed by the steps shown in FIGS. 6 and 7.

According to the present disclosure, it is possible to individually detect photovoltaic strings with ground fault (that is, faulty photovoltaic string) through the photovoltaic string ground fault determination, and to minimize power generation loss due to the occurrence of the ground fault by re-starting photovoltaic power generation using the remaining photovoltaic strings except the faulty photovoltaic string.

Second, by performing pre-check before the operation of the inverter for photovoltaic power generation, it is possible to prevent safety incidents due to the occurrence of the ground fault, and to minimize power generation loss.

Third, by providing location information of the faulty photovoltaic string through an alarm, it is possible to quickly deal with the ground fault, and to increase maintenance convenience of the photovoltaic power generating system.

Finally, by turning off the relay of the fault detector in detecting the ground fault of the photovoltaic string so that current does not flow to the inverter, it is possible to prevent device damage due to occurrence of arc.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A photovoltaic power generating system comprising:
a plurality of photovoltaic strings including a plurality of photovoltaic modules connected in series;
an inverter that converts direct current supplied from the photovoltaic strings into alternating current and transmits the converted current to a power-consuming device; and
a controller that determines whether a ground fault occurs in each of the photovoltaic strings by measuring actual open-circuit voltages of the photovoltaic strings, and electrically disconnects a faulty photovoltaic string in which the ground fault occurs among the plurality of photovoltaic strings from the inverter.

2. The system according to claim 1, wherein the controller transmits location information of the faulty photovoltaic string to a monitoring device, and the monitoring device generates an alarm for providing the location information of the faulty photovoltaic string.

3. The system according to claim 1, wherein the controller stops, in a case where a ground fault detection signal is received from the inverter after the operation of the inverter is started, the operation of the inverter and then compares the actual open-circuit voltage of each photovoltaic string with a predetermined reference open-circuit voltage, and determines a photovoltaic string having the actual open-circuit voltage smaller than a predetermined percentage value of the reference open-circuit voltage as the faulty photovoltaic string.

4. The system according to claim 3, wherein the controller determines that the photovoltaic string having the actual open-circuit voltage equal to or greater than the predetermined percentage value of the reference open-circuit voltage is not the faulty photovoltaic string.

5. The system according to claim 1, wherein the photovoltaic strings and the inverter are connected through a plurality of string output lines.

6. The system according to claim 5, wherein a relay is provided on each of the string output lines for selectively blocking the connection between the photovoltaic strings and the inverter.

7. The system according to claim 6, wherein a string voltage detecting section for measuring the actual open-circuit voltage of each of the photovoltaic strings is provided in each of the string output lines in a state in which the relay is in an off state.

8. The system according to claim 6, wherein the controller compares, in a case where an open-circuit voltage of a photovoltaic array measured in a combiner box output line that connects the relay and the inverter is equal to or greater than a predetermined pre-check operation starting voltage, the actual open-circuit voltage of each of the photovoltaic strings with a predetermined reference open-circuit voltage before the operation of the inverter is started, and determines a photovoltaic string having the actual open-circuit voltage smaller than a predetermined percentage value of the reference open-circuit voltage as the faulty photovoltaic string.

9. The system according to claim 8, wherein the controller determines that the photovoltaic string having the actual open-circuit voltage equal to or greater than the predetermined percentage value of the reference open-circuit voltage is not the faulty photovoltaic string.

10. The system according to claim 6, wherein the controller re-starts power generation of the remaining photovoltaic strings except the faulty photovoltaic string among the plurality of photovoltaic strings in a state in which the relay on the string output line connected to the faulty photovoltaic string maintains an off state.

11. The system according to claim 6, wherein the controller measures an open-circuit voltage of a photovoltaic array on a combiner box output line that connects the relay and the inverter, and determines, in a case where the open-circuit voltage of the photovoltaic array is smaller than a predetermined percentage value of a predetermined reference open-circuit voltage, that the ground fault occurs on the combiner box output line.

12. The system according to claim 11, wherein the open-circuit voltage of the photovoltaic array is measured in a state in which all of the relays provided on the string output lines are in an off state.

13. The system according to claim 12, wherein the photovoltaic array is configured by connecting the plurality of photovoltaic strings in parallel.

14. The system according to claim 11, wherein the controller is configured to generate an alarm for indicating the occurrence of the ground fault in the combiner box output line.

15. The system according to claim 11, wherein the controller determines, in a case where the open-circuit voltage of the photovoltaic array is equal to or greater than the predetermined percentage value of the reference open-circuit voltage, that the ground fault does not occur on the combiner box output line.

16. The system according to claim 13, wherein the controller measures the open-circuit voltage of the photovoltaic array in a state in which only the relay connected to one target photovoltaic string among the plurality of photovoltaic strings is turned on, and determines, in a case where the open-circuit voltage of the photovoltaic array is equal to or greater than the predetermined percentage value of the reference open-circuit voltage, the target photovoltaic string as the faulty photovoltaic string.

17. The system according to claim 16, wherein the controller determines, in a case where the open-circuit voltage of the photovoltaic array is smaller than the predetermined percentage value of the reference open-circuit voltage, that the target photovoltaic string is not the faulty photovoltaic string.

18. The system according to claim 16, wherein the controller transmits location information of the faulty photovoltaic string to a monitoring device, and generates an alarm for indicating a location of the faulty photovoltaic string through the monitoring device.

19. A photovoltaic power generating method comprising:
converting, by an inverter, direct current supplied from a plurality of photovoltaic strings into alternating current and transmitting the converted current to a power-consuming device;
determining, by a controller, whether a ground fault occurs in each of the photovoltaic strings by measuring actual open-circuit voltages of the photovoltaic strings, and
electrically disconnecting, by the controller, a faulty photovoltaic string in which the ground fault occurs among the plurality of photovoltaic strings from the inverter.

20. The method according to claim 19, wherein the controller transmits location information of the faulty photovoltaic string to a monitoring device, and the monitoring device generates an alarm for providing the location information of the faulty photovoltaic string.
